(19) United States
(12) Patent Application Publication
(10) Pub. No.: US 2024/0267314 A1
(43) Pub. Date: Aug. 8, 2024

(54) NETWORK THROUGHPUT TESTS AT PREDEFINED THRESHOLDS

(71) Applicant: VIAVI SOLUTIONS INC., Chandler, AZ (US)

(72) Inventors: Hans-Joerg WOLF, Woodbine, MD (US); Reynald DUPUIS, Germantown, MD (US); Jay Sovick LESTER, Indianapolis, IN (US); Gregory Scott TOPMILLER, Rockville, MD (US); Ying PAN, Frederick, MD (US)

(73) Assignee: VIAVI SOLUTIONS INC., Chandler, AZ (US)

(21) Appl. No.: 18/107,284

(22) Filed: Feb. 8, 2023

(51) Int. Cl. H04L 43/0888

(52) U.S. Cl. CPC H04L 43/0888

(57) ABSTRACT

According to examples, an apparatus may include a hardware processor that may determine throughputs at which servers communicated over a network through execution of throughput tests with the servers. The hardware processor may also identify which of the servers communicated over the network at a throughput that meets or exceeds a predefined throughput and may send identifiers of the servers to a test service provider. The test service provider may, in response to receipt of a request for execution of a throughput test that meets or exceeds the predefined throughput, at least one of output an identifier of at least one of the identified servers to execute the throughput test and select one of the identified servers to execute the throughput test. The hardware processor may also cause a test instrument to execute a throughput test with the identified server at or above the predefined throughput.

### TECHNICAL FIELD

The disclosure relates generally to apparatuses for executing network connection throughput tests and particularly to apparatuses for executing network connection throughput tests with servers that are capable of meeting or exceeding certain throughputs.

### BACKGROUND

Various tools from test service providers are available to users to test network characteristics of their devices. The tests are often identified as “speed tests” or “Internet speed tests.” In these tests, a series of packets may be communicated between a user's device and a remote server and the network characteristics may be calculated from the communication of the series of packets. The network characteristics may include, ping, throughput, round trip time (RTT), latency, jitter, and/or loss. The network characteristics may also include a download speed and an upload speed of an Internet connection of the user's device. An example of a web browser based tool for testing network characteristics is Ookla™, available from Ookla, LLC., of Seattle, WA, USA.

### BRIEF DESCRIPTION OF THE DRAWINGS

Features of the present disclosure may be illustrated by way of example and not limited in the following figure(s), in which like numerals indicate like elements, in which:

FIG. 1A shows a block diagram of a test instrument for performing tests and measurements, according to an example of the present disclosure;

FIG. 1B shows a block diagram of a network environment, in which an apparatus may execute throughput tests through the test instrument shown in FIG. 1A and identify servers that communicated over a network with the test instrument at a throughput that meets or exceeds a predefined throughput, according to an example of the present disclosure;

FIGS. 2 and 3, respectively, depict block diagrams of the apparatus depicted in FIG. 1B, according to examples of the present disclosure;

FIGS. 4A-4H, respectively, show screenshots of example graphical user interfaces (GUIs), according to examples of the present disclosure;

FIG. 5 depicts a flow diagram of a method for executing a throughput test for a test instrument with a server that is capable of communicating with the test instrument at or above a predefined throughput, according to an example of the present disclosure; and

FIG. 6 shows a block diagram of a computer-readable medium that may have stored thereon computer-readable instructions to execute a throughput test for a test instrument with a server that is capable of communicating with the test instrument at or above a predefined throughput, according to an example of the present disclosure.

### DETAILED DESCRIPTION

In the following description, numerous specific details are set forth in order to provide a thorough understanding of the present disclosure. It will be readily apparent however, that the present disclosure may be practiced without limitation to these specific details. In other instances, some methods and structures readily understood by one of ordinary skill in the art have not been described in detail so as not to unnecessarily obscure the description of the present disclosure. Also, for simplicity and illustrative purposes, the present disclosure is described below by referring mainly to examples. As used herein, the terms “a” and “an” are intended to denote at least one of a particular element, the term “includes” means includes but not limited to, the term “including” means including but not limited to, and the term “based on” means based at least in part on.

Test service providers, such as Ookla™, often select servers against which computing devices are to execute throughput tests based primarily on the geographical distances between a computing device to be tested and the testing servers. Particularly, the test service providers may select the testing server based on ping results, e.g., the testing servers with the fastest pings with respect to the computing devices may be selected for testing of the computing devices. The pings may be determined using a single small packet whereas the testing of the computing devices may be performed using stream oriented transfer (TCP).

In some instances, some of the available testing servers may be incapable of communicating data packets at certain throughputs due to, for instance, network connectivity configurations and/or issues. The test service providers may not track the throughput capabilities of the available testing servers. As a result, the test service providers may, in many instances, select testing servers that are incapable of meeting certain throughputs for the computing devices to use in testing the throughputs of their network connections.

A technical issue associated with conventional network connection testing of computing devices may be that network connections having certain throughputs may not be tested. That is, when testing servers that are incapable of reaching certain throughputs, e.g., 5 gigabits per second or higher, are selected for a computing device, testing of network connections at or above the certain throughputs may not be possible through communications of data packets between the computing device and the testing servers. As a consequence, the tests may result in inaccurate test results, such as incorrect download and upload speeds. The inaccurate test results may thus not be relied upon to determine whether a network connection of the computing device has been installed properly and/or is operating properly.

Disclosed herein are apparatuses, methods, and computer-readable media that may enable testing of network connections to be executed accurately, particularly at higher throughputs, such as 5 gigabits or higher. Particularly, a hardware processor as disclosed herein may determine throughputs at which a plurality of servers communicated over a network, for instance, with the apparatus and/or a test instrument. The hardware processor may determine the throughputs through execution of throughput tests with the plurality of servers and the apparatus and/or the test instrument. The hardware processor may identify which of the servers in a certain geographical area communicated over the network with the apparatus and/or the test instrument at a throughput that meets or exceeds a predefined throughput, e.g., 2.5 gigabits per second, 5 gigabits per second, 10 gigabits per second, or higher. In other words, the hardware processor may identify which of the network connections to the servers have throughputs that meet or exceed the predefined threshold.

For those servers in the certain geographical area that have throughputs that meet or exceed the predefined threshold, the hardware processor may send identifiers of those servers to a test service provider. The test service provider may store the identifiers of those servers as servers that are capable of meeting or exceeding the predefined threshold. In addition, the test service provider may, in response to receipt of a request for execution of a throughput test that meets or exceeds the predefined throughput from a computing device, output an identifier of at least one of the identified servers to execute the throughput test to the computing device. In addition, or alternatively, the test service provider may select one of the identified servers to execute the throughput test with the computing device. As a result, the computing device, which may be the apparatus having the hardware processor or another apparatus, may cause a test instrument o execute a throughput test with a server that is known to have a network connection that is capable of meeting or exceeding a predefined threshold.

Through implementation of the features of the present disclosure, the network connection throughput testing may be executed with servers that are capable of meeting or exceeding the predefined threshold. This may cause the accuracy of the network connection throughput testing to be increased, particularly for higher throughput network connections. The results of the network connection throughput testing may thus be used to accurately determine whether a network connection has been installed properly and/or is operating properly. In addition, by accurately making this determination, the number of network connection throughput tests may be reduced or minimized, which may reduce the amount of computing resources and energy consumed in determining the network connection throughputs.

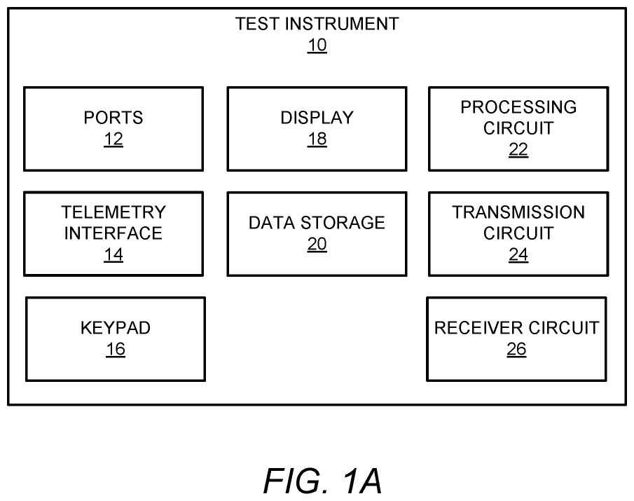

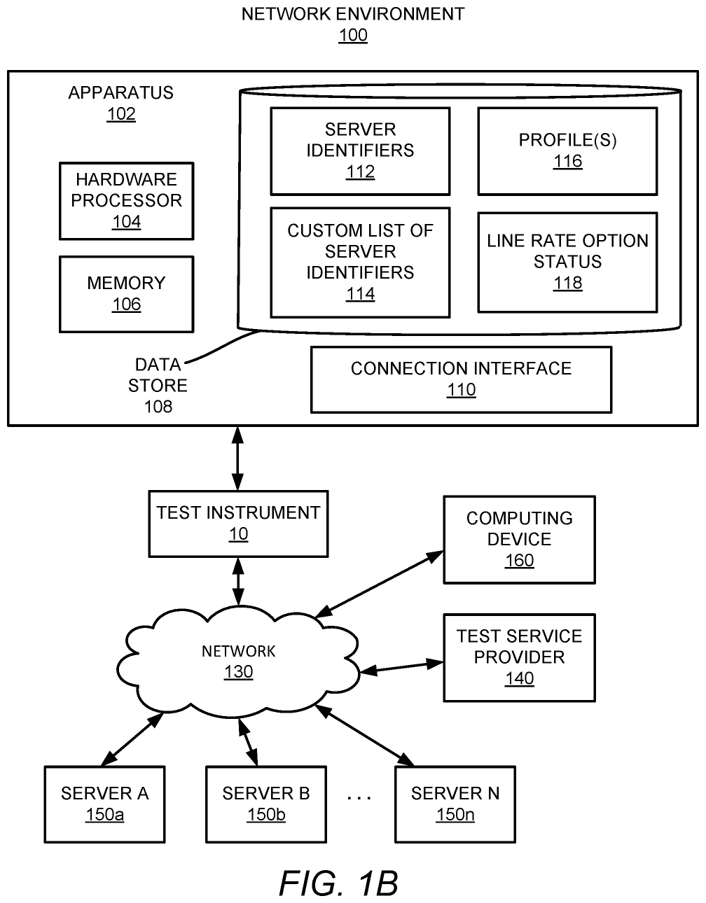

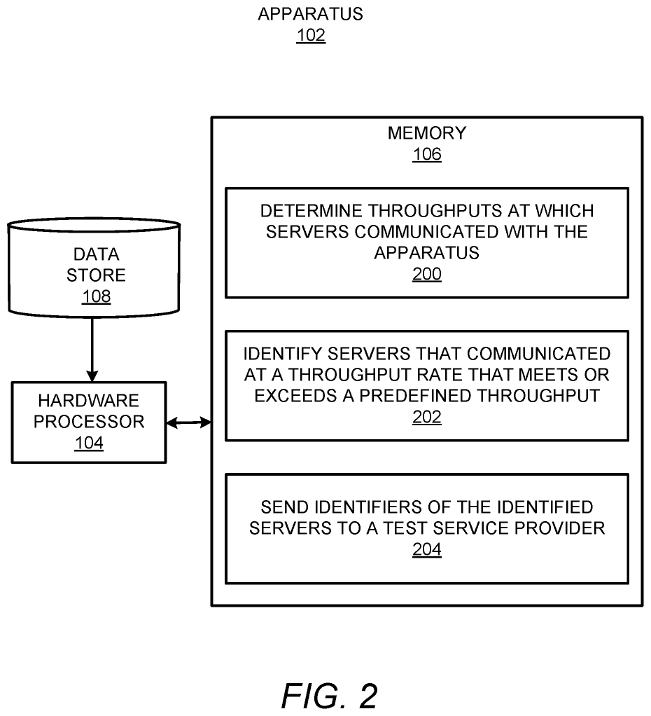

Reference is first made to FIGS. 1A, 1B, and 2. FIG. 1A shows a block diagram of a test instrument 10 for performing tests and measurements, according to an example of the present disclosure. FIG. 1B shows a block diagram of a network environment 100, in which an apparatus 102 may execute throughput tests through the test instrument 10 shown in FIG. 1A and identify servers that communicated over a network with the test instrument 10 at a throughput that meets or exceeds a predefined throughput, according to an example of the present disclosure. FIG. 2 depicts a block diagram of the apparatus 102 depicted in FIGS. 1A and 1B, according to an example of the present disclosure. It should be understood that the network environment 100 and/or the apparatus 102 may include additional features and that some of the features described herein may be removed and/or modified without departing from the scopes of the network environment 100 and/or the apparatus 102.

The test instrument 10 shown in FIG. 1A may perform a variety of tests and measurements. In some examples, the test instrument 10 may perform tests and measurements on an optical cable, an optical (pluggable) transceiver, an Ethernet cable, and/or the like. The test instrument 10 may be able to perform any number of network tests by generating, transmitting, and/or receiving high-speed signals. In some examples, the test instrument 10 may be a computing device that is designed and configured to perform testing operations on networks. For instance, the test instrument 10 may be a network and service companion (NSC) available from Viavi® of Chandler, AZ. The network and service companion may be defined as a compact hand-held device that combines multiple test interfaces for network validation and multi-gig service testing. In some examples, the test instrument 10 may be a Viavi® test instrument, including, but not limited to, T-BERD® 5800-100G, ONA-800, NSC-100, NSC-200, or other related Viavi® or non-Viavi® devices, etc.

The test instrument 10 may include a variety of internal or external components. For instance, the test instrument 10 may be connected to a network (e.g., an optical network) at any desired test point (TP) to measure signals transmitted in the network. In some examples, this may involve using any number of (pluggable) transceivers (not shown). The test instrument 10 may also include one or more ports 12 into which various types of connectors may be inserted. In some examples, the ports 12 may be used to connect to one or more test points (TPs). It should be appreciated that these ports 12 may include an adapter interface to test an optical transceiver. In some examples, the ports 12 may include coaxial RF cable connectors, as well as other non-cable ports, for example, to connect to a computer or to an external display, such as, but not exclusively, one or more USB ports, telephone, Ethernet, optical interface, Gigabit Ethernet passive optical network (GPON) interface, data over cable service interface specification (DOCSIS) interface, digital subscriber line (DSL) interface, and/or the like.

The test instrument 10 may also include a telemetry interface 14 for connecting to a telemetry channel, such as a WiFi interface, Bluetooth interface, cellular interface or another network interface. The telemetry interface 14 may function as an additional communication channel. For example, the test instrument 10 may connect to a remote device such as the apparatus 102 via the telemetry interface 14 as discussed in greater detail herein.

The test instrument 10 may include a user interface which may include a keypad 16 and a display 18. For example, the display 18 may include a touch screen display or other display, such as a liquid crystal display (LCD) or light emitting diode (LED) display. In some examples, a user (e.g., a technician) may interact with the test instrument 10 via the user interface 16, 18 to enter information, select operations, view measurements, examine signal profiles, communicate with other devices, etc.

The test instrument 10 may also include a data storage 20 that may store information used by the test instrument 10. The data storage 20 may include memory or another type of data storage device. The data storage 20 may store data, power level measurements and/or any other measurements or data used by the test instrument 10. The data storage 20 may include a non-transitory computer readable medium storing machine-readable instructions executable by a processing circuit 22 to perform various actions or operations of the test instrument 10.

The test instrument 10 may also include a transmission circuit 24 that may send test signals into the network to perform various tests. The transmission circuit 24 may include, among other things, encoders, modulators, and other components for transmitting signals in the network. The test instrument 10 may further include a receiver circuit 26 that may include components for receiving signals from the network. The transmission circuit 24 and/or the receiver circuit 26 may also include other components, such as a demodulator, a decoder, an ADC, and/or other circuit components or elements.

The processing circuit 22 in the test instrument 10 may include any suitable hardware to perform the operations of the test instrument 10 described herein. The hardware of the test instrument 10, including the processing circuit 22, may include at least one of a hardware processor, a microcontroller, a digital signal processor (DSP), an application specific integrated circuit (ASIC), a field programmable gate array (FPGA) or other programmable logic device, discrete gate or transistor logic, discrete hardware components, or any combination thereof designed to perform the functions and methods described herein. In an example, one or more of the functions and operations of the test instrument 10 described herein may be performed by the processing circuit 22 or other hardware executing machine readable instructions stored in a non-transitory computer readable medium, which may include RAM (random access memory), ROM (read only memory), EPROM (erasable, programmable ROM), EEPROM (electrically erasable, programmable ROM), hard drives, flash memory, or other types of storage devices, which may be volatile and/or nonvolatile. It should be appreciated that the test instrument 10 may also include components other than what is shown in FIG. 1A.

As shown in FIG. 1B, the network environment 100 includes an apparatus 102, which may include a hardware processor 104, a memory 106, and a data store 108. In some examples, the apparatus 102 may be a computing device such as a smartphone, a laptop computer, a desktop computer, a tablet computer, and/or the like. The hardware processor 104 may control operations of the apparatus 102 and may be a semiconductor-based microprocessor, a central processing unit (CPU), an application specific integrated circuit (ASIC), a field-programmable gate array (FPGA), and/or other hardware device. References made herein to the apparatus 102 performing various operations should equivalently be construed as meaning that the hardware processor 104 of the apparatus 102 may perform those various operations.

The memory 106 may have stored thereon instructions that the hardware processor 104 may access and/or may execute. In addition, the hardware processor 104 may store and access various information in the data store 108 as discussed herein. The memory 106 and the data store 108 may each be a computer-readable medium, such as a Random Access memory (RAM), an Electrically Erasable Programmable Read-Only Memory (EEPROM), a storage device, or the like. The memory 106 and the data store 108 may be a non-transitory computer-readable storage medium, where the term “non-transitory” does not encompass transitory propagating signals.

Although the apparatus 102 is depicted as having a single hardware processor 104, it should be understood that the apparatus 102 may include additional processors and/or cores without departing from a scope of the apparatus 102. In this regard, references to a single hardware processor 104 as well as to a single memory 106 may be understood to additionally or alternatively pertain to multiple hardware processors 104 and/or multiple memories 106. In addition, or alternatively, the hardware processor 104 and the memory 106 may be integrated into a single component, e.g., an integrated circuit on which both the hardware processor 104 and the memory 106 may be provided. In addition, or alternatively, the operations described herein as being performed by the hardware processor 104 may be distributed across multiple hardware processors 104.

The apparatus 102 may communicate with the test instrument 10 through a connection interface 110, which may be a Bluetooth interface, a WiFi interface, or the like. In addition, the test instrument 10 may connect to a network 130 through one or more of the ports 12. The test instrument 10 may transmit and/or receive data through the one or more ports 12. The network 130 may be an internal network, such as a local area network, an external network, such as the Internet, or a combination thereof. Examples of the ports 12 in the test instrument 10 may be a wireless fidelity (WiFi) interface or antenna, an Ethernet port, a small form factor pluggable (SFP) port, an optical interface port, a GPON interface port, a DOCSIS interface port, a DSL interface port, and/or the like.

The network environment 100 is also depicted as including a test service provider 140 and a plurality of servers 150a-150n, in which the variable “n” represents a value greater than one. The test service provider 140 may provide a tool, such as a web based tool, through which computing devices 160, such as the test instrument 10, may perform throughput tests on their network connections. The throughput tests may be tests that the computing devices 160 may execute to determine the throughputs at which data may be communicated through connection interfaces, such as Ethernet ports, Wifi connections, etc.

In some examples, the test instrument 10 may communicate data pertaining to results of the throughput tests to the apparatus 102. For instance, the apparatus 102 may have stored thereon an application that interfaces with the test instrument 10 such that data collected by the test instrument 10 may be displayed in various fields on the apparatus 102. The application may also provide an interface through which a user may control operations of the test instrument 10 as discussed in greater detail herein. In some examples, the hardware processor 104 may determine, for instance, the throughput at which data is downloaded from a server 150a and the throughput at which data is uploaded to the server 150a from the data received from the test instrument 10. The throughput may be defined as the amount of data moved successfully from one computing device to another computing device in a given time period. In addition, the throughput may be a reflection of the speed of a connection from an internet service provider (ISP) or carrier of the computing device 160.

In some instances, the test service provider 140 may provide a portal or a web application through which the test instrument 10, the apparatus 102, and the computing devices 160 may request execution of throughput tests of their network connections. In response to receipt of a throughput test request from a computing device 160, the test service provider 140 may identify a server 150a of the servers 150a-150n against which the computing device 160 is to perform the throughput test. The servers 150a-150n may include a set of servers that the test service provider 140 has identified as being available for the computing devices 160 to perform the throughput tests. The servers 150a-150n may also include a set of servers that are within a certain geographic distance of the computing devices 160. In this regard, the servers 150a-150n may be in other geographic locations when the computing devices to be tested are in other geographic locations.

In some instances, the test service provider 140 may select the server 150a based on a ping result, e.g., the server 150a with the fastest ping. The ping may be defined as the length of time that it takes for a packet of data to travel from a computing device 160 to the server 150a over the network 130 and back over the network 130. The ping may be affected by the distance between the computing device 160 and the server 150A and thus, the test service provider 140 may select a server 150a that is in relatively close geographic distance from the computing device 160.

The test service provider 140 may inform the computing device 160 of the selected server 150a. The computing device 160 may execute the throughput test by sending a message to the selected server 150 over a selected port. For instance, the test instrument 10 may send the message, e.g., TCP packets, to the selected server 150 through a selected port 12. Upon receiving the message, the server 150a may send a reply back to the computing device 160. The computing device 160 may measure the round-trip time, for instance, in milliseconds. The computing device 160 and the server 150a may repeat this test multiple times and, for instance, the computing device 160 may select the lowest value as the final result of the throughput test.

In some examples, to determine the download speeds, the computing device 160 may establish multiple connections with the server 150a. The computing device 160 may request that the server 150a send an initial chunk of data. The computing device 160 may calculate the real-time speed of the transfers and may adjust the chunk size and buffer size based on this calculation to maximize usage of the network connection. As the computing device 160 receives the chunks of data, the computing device 160 may request more chunks of data throughout the duration of the test. During the first half of the test, the computing device 160 may establish extra connections to the server 150a if the computing device 160 determines additional threads may more accurately measure the download speed. The test may end once a configured amount of time has been reached.

In some instances, the computing device 160 may establish multiple connections with the server 150a over a defined port and may send an initial chunk of data. The computing device 160 may calculate the real-time speed of the transfers and may adjust the chunk size and buffer size based on the real-time speed to maximize usage of the network connection, and may request more data. As the server 150a receives the chunks of data, the computing device 160 may send more chunks of data throughout the duration of the test. During the first half of the test, the computing device 160 may establish extra connections to the server if the computing device 160 determines additional threads may more accurately measure the upload speed. The test may end once a configured amount of time has been reached.

According to examples and as discussed herein, the hardware processor 104 may perform throughput tests on the servers 150a-150n in a geographical area. The hardware processor 104 may perform the throughput tests directly or via the test instrument 10. The hardware processor 104 may also determine, from the throughput tests, which of the servers 150a-150n in the geographical area communicated over the network 130 with the apparatus 102 at the highest throughputs, e.g., throughputs that meets or exceeds the predefined throughput. The hardware processor 104 may inform the test service provider 140 of those servers 150a-150n. In addition, at a later time, the test service provider 140 may select one of those servers 150a-150n as the server that a computing device 160 is to communicate with to perform a throughput test when a test of a network connection that meets or exceeds the predefined throughput is requested.

As shown in FIG. 2, the memory 106 may have stored thereon machine-readable instructions 200-204 that the hardware processor 104 may execute. As shown, the hardware processor 104 may execute the instructions 200 to determine throughputs at which a plurality of servers 150a-150n communicated over a network 130 with the apparatus 102. The hardware processor 104 may determine the throughputs through execution of throughput tests with the plurality of servers 150a-150n. The hardware processor 104 may cause the test instrument 10 to execute the throughput tests with the servers 150a-150n through the test service provider 140 as discussed herein.

For instance, the hardware processor 104 may receive identifiers of the servers 150a-150n from the test service provider 140. The identifiers of the servers 150a-150n may be any suitable form of identification of the servers 150a-150n, such as IP addresses, names, numeric identifiers, geographic locations of the servers 150a-150n, and/or the like. The hardware processor 104 may also cause the test instrument 10 to execute the throughput tests on some or all of the servers 150a-150n sequentially or in another order, such as geographic proximity to the apparatus 102. In some examples, the hardware processor 104 may automatically cause the test instrument 10 to execute the throughput tests on the selected servers 150a-150n, while in other examples, a user may instruct the hardware processor 104 to execute the throughput tests. The hardware processor 104 may further determine the throughputs of the communications that the test instrument 10 had with the servers 150a-150n over the network 130. In other examples, the hardware processor 104 may directly execute the throughput tests with the servers 150a-150n, e.g., without using the test instrument 10.

The hardware processor 104 may execute the instructions 202 to identify which servers 150a-150I of the plurality of servers 150a-150n communicated over the network 130 with the test instrument 10 and/or the apparatus 102 at a throughput that meets or exceeds a predefined throughput. The variable “I” may represent a value greater than one. The predefined throughput may be, for instance, one of 2.5 gigabits per second, 5 gigabits per second, 10 gigabits per second, or faster. In some examples, the predefined throughput may be user defined.

The hardware processor 104 may have determined the identifiers 112 of the servers 150a-150I when the throughput tests with the servers 150a-150I were executed. In addition, the hardware processor 104 may store the server identifiers 112 in the data store 108. The hardware processor 104 may execute the instructions 204 to send the server identifiers 112 to the test service provider 140. Particularly, for instance, the hardware processor 104 may send the server identifiers 112 to the test service provider 140 with an indication that the server identifiers 112 correspond to servers 150a-150I that communicated over the network 130 with the apparatus 102 at a throughput that meets or exceeds a predefined throughput.

The test service provider 140 may store the server identifiers 112 along with the predefined throughput that the servers 150a-150I meets or exceeds. In addition, when the test service provider 140 receives requests for the execution of throughput tests that meet or exceed the predefined throughput from computing devices, the test service provider 140 may provide identifiers of at least one of the servers 150a-150I to the requesting computing devices 160. The requesting computing devices 160 may execute the throughput tests using the servers 150a-150I identified by the test service provider 140.

In addition, or alternatively, the test service provider 140 may select one of the identified servers 150a-150I to execute the throughput test. In these examples, the test service provider 140 may select one of the identified servers 150a-150I and may cause the requesting computing device 160 to execute the throughput test with the selected server 150a. In any of these examples, the test service provider 140 may select one or more of the identified servers 150a-150I based on the geographic locations of the computing device 160 and the servers 150a-150I. Particularly, for instance, the test service provider 140 may select the one or more of the identified servers 150a-150I having the fastest pings with the requesting computing device.

In some examples, the hardware processor 104 may define a set of the identified servers 150a-150I as a custom list of servers for an organization. The hardware processor 104 may store the custom list of server identifiers 114 in the data store 108. In addition, the hardware processor 104 may send the custom list of server identifiers 114 to the test service provider 140. The test service provider 140 may, in response to receipt of a request for execution of a throughput test that meets or exceeds the predefined throughput from a member of the organization, output an identifier of at least one of the servers in the custom list of server identifiers 114 to execute the throughput test. In addition, or alternatively, the hardware processor 104 or a user of the apparatus 102 may select one of the identified servers in the custom list of server identifiers 114 with which to execute the throughput test.

In some examples, the hardware processor 104 may identify which servers 150a-150k of the plurality of servers 150a-150n communicated over the network 130 with the apparatus 102 at a throughput that meets or exceeds a second predefined throughput. The variable “k” may represent a value greater than one. The second predefined throughput may differ from the predefined throughput, which may also be termed a first predefined throughput herein. By way of example, the predefined throughput may be 5 gigabits per second and the second predefined throughput may be 10 gigabits per second.

In these examples, the hardware processor 104 may send identifiers 112 of the set of servers 150a-150k to the test service provider 140. The test service provider 140 may, in response to receipt of a request for execution of another throughput test that meets or exceeds the second predefined throughput, output an identifier 112 of at least one of the servers in the set of servers 150a-150k to execute the other throughput test. In addition, or alternatively, the test service provider 140 may select one of the servers in the set of servers 150a-150k to execute the other throughput test.

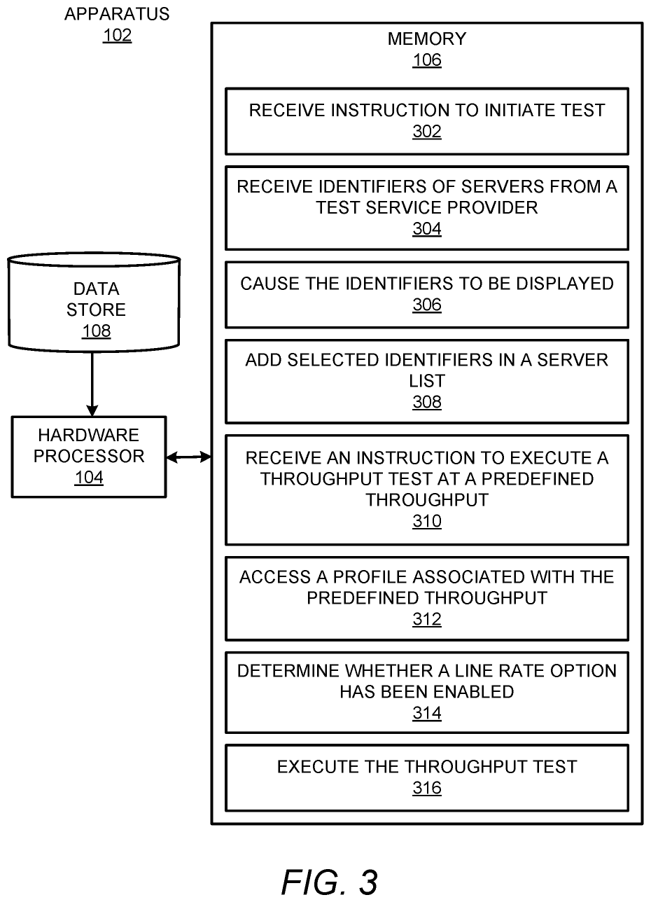

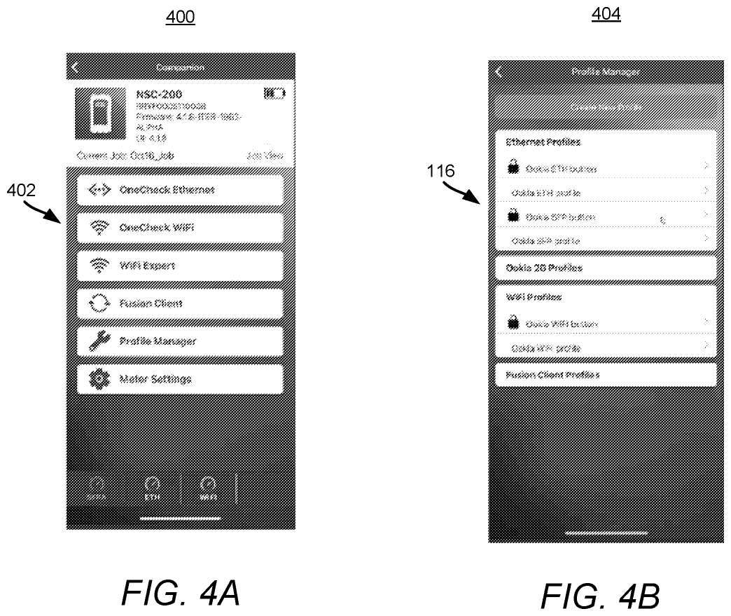

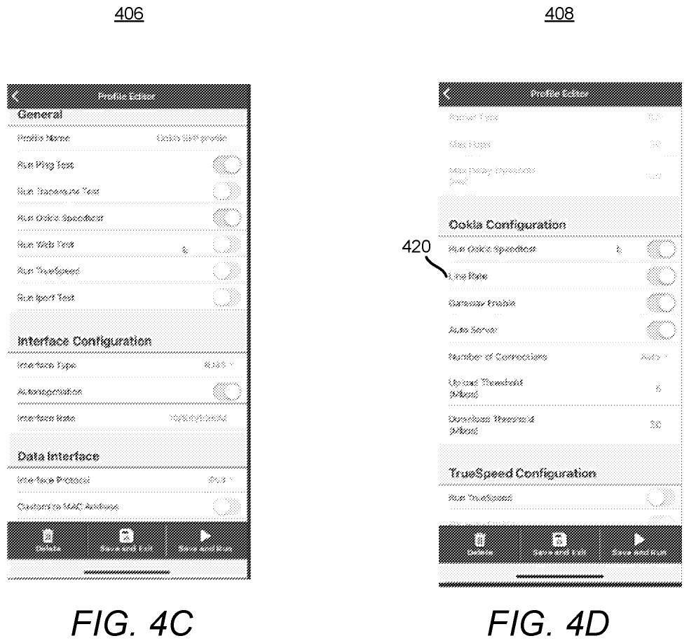

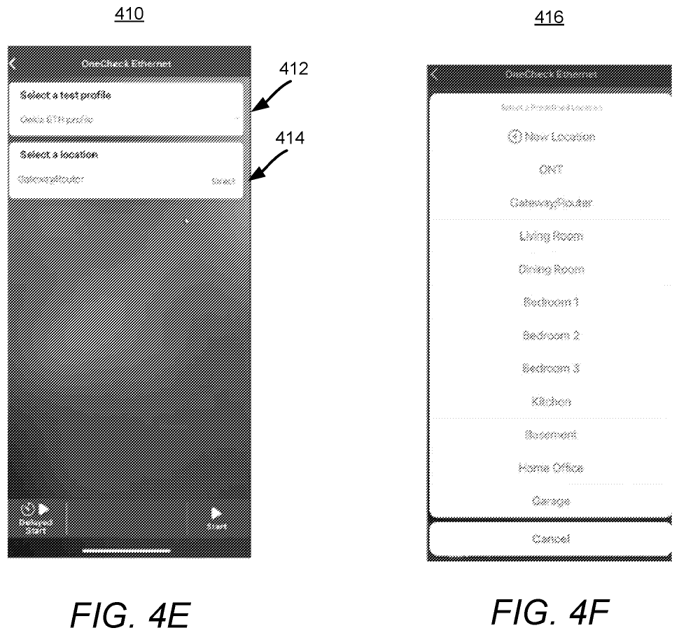

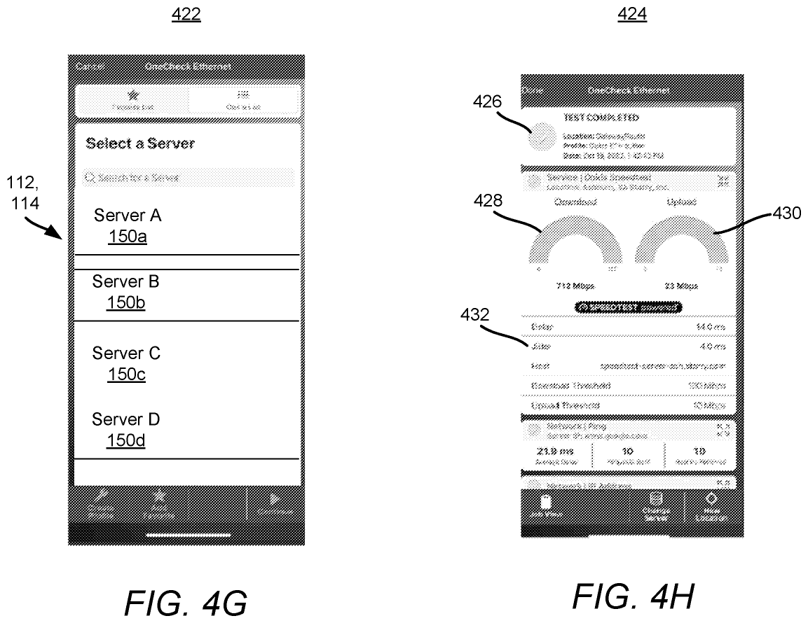

Reference is now made to FIG. 3, which shows a block diagram of the apparatus 102 depicted in FIG. 1B, according to an example of the present disclosure. It should be understood that the apparatus 102 may include additional features and that some of the features described herein may be removed and/or modified without departing from the scope of the apparatus 102 disclosed herein. The features shown in FIG. 3 are described with respect to the features shown in FIGS. 4A-4H for purposes of illustration. FIGS. 4A-4H, respectively, depict screenshots of example graphical user interfaces (GUIs) that may be displayed on a screen of the apparatus 102, according to examples of the present disclosure. The GUIs may be part of an application executing on the apparatus 102 that interfaces with the test instrument 10.

The hardware processor 104 may execute the instructions 302-316 as a separate set of operations from the instructions 200-204 depicted in FIG. 2. For instance, the apparatus 102 or another apparatus (not shown) may have determined identifiers of servers 150a-150I that communicated over the network 130 with the test instrument 10, the apparatus 102, or another apparatus at a throughput that meets or exceeds the predefined throughput. The apparatus 102 or another apparatus may have also sent the identifiers of the servers 150a-150I to the test service provider 140 prior to execution of the instructions 302-316. In some examples, the hardware processor 104 may execute the instructions 302-316 at a later time from when the hardware processor 104 sent the identifiers of the servers 150a-150I, after the test instrument 10 and the apparatus 102 have been moved to another location, such as another geographic area, and/or the like.

The hardware processor 104 may execute the instructions 302 to receive an instruction to initiate a throughput test. According to examples, a user of the apparatus 102 may cause the hardware processor 104 to display a GUI, which displays an option for a user to initiate execution of a throughput test, e.g., a network connection throughput test, with a server 150a that has a throughput that meets or exceeds a predefined threshold. A screenshot of an example GUI 400 that includes the option for a test to be executed using a certain profile is shown in FIG. 4A. Particularly, for instance, a user may select one of the options 402 displayed in the GUI 400, in which selection of the option 402 may cause a throughput test to be executed using the profile 116 corresponding to the selected option 402. In other words, once the profile 116 for one of the options 402 has been set, a user may merely press the option 402 to initiate a throughput test, for instance, as a “one click” operation. In some examples, the instruction to initiate the test may be an instruction to initiate a test at a throughput that is below the predefined threshold.

As also shown in FIG. 4A, the GUI 400 may provide the user with options to select one of the ports 12 on the test instrument 10 to be used in a throughput test. As discussed herein, the ports 12 may include a SFP port, an Ethernet port, a WiFi connection, an optical interface, a GPON interface, a DOCSIS interface, a DSL interface, and/or the like. In some examples, the port 12 through which data packets are to be sent and received during the throughput test may have been predefined and stored as part of a test profile 116. A screenshot 404 of an example GUI that shows test profiles 116 is depicted in FIG. 4B.

According to examples, a user may set or define the properties of the one or more test profiles 116 through a profile editor feature of the application. Screenshots of example profile editor GUIs 406, 408 are respectively shown in FIGS. 4C and 4D. The GUIs 406, 408 are shown as providing various options that may be included in selected profiles 116. A user may thus select various features for the profiles 116 corresponding to the options 402 shown in the GUI 400.

In some examples, a user may select both the test profile 116 and a location at which a test is to be performed. For instance, the hardware processor 104 may cause a GUI 410 as shown in FIG. 4E to be displayed. As shown in FIG. 4E, the GUI 410 may provide a user with options to select among the profiles 116 and a location at which the test is to be executed. The options may be in the form of icons 412, 414 that a user may select. Particularly, when a user selects the icon 414, the hardware processor 104 may cause a GUI 416 that shows various locations at which the tests may be performed to be displayed. A screenshot of the example GUI 416 is shown in FIG. 4F.

Following receipt of the instruction to initiate the test, the hardware processor 104 may initiate the test based on the selected test profile 116. This may include the output of a request to the test service provider 140 to initiate the test. As discussed herein, the test service provider 140 may have access to the identifiers of the servers 150a-150I that communicated over the network 130 at a throughput that meets or exceeds a predefined throughput. The test service provider 140 may provide the apparatus 102 with the identifiers of one or more of those servers 150a-150I. For instance, the test service provider 140 may identify which of the servers 150a-150I have the fastest pings with respect to the apparatus 102 and may provide the apparatus 102 with the identifiers of those servers 150a-150I. The apparatus 102 may communicate with the test service provider 140 directly or through the test instrument 10. In examples in which the throughput test is for a test at a throughput that is below the predefined threshold, the test service provider 140 may provide the apparatus 102 with a list of some of the available servers 150a-150n regardless of their respective throughputs.

The hardware processor 104 may execute the instructions 304 to receive identifiers 112, 114 of servers 150a-150I that communicated over the network 130 at a throughput that meets or exceeds a predefined throughput. In some examples, the hardware processor 104 may also receive identifiers 112, 114 of servers 150a-150k that communicated over the network 130 at a throughput that meets or exceeds a second predefined throughput. By way of example, the predefined throughput may be 5 gigabits per second and the second predefined throughput may be 10 gigabits per second. In some examples, the test service provider 140 may send the identifiers 112, 114 of the servers 150a-150 and/or the servers 150a-150k in response to receipt of a request to execute a throughput test from the hardware processor 104 at a throughput that meets or exceeds the predefined throughput or the second predefined throughput.

The hardware processor 104 may execute the instructions 306 to cause the identifiers 112, 114 to be displayed. For instance, the apparatus 102 may include an integrated display (not shown) on which a listing of the identifiers 112, 114 may be displayed. In other examples, the apparatus 102 may be connected to an external display (not shown) and the listing of identifiers 112, 114 may be displayed on the external display. A screenshot of an example graphical GUI 422 in which a listing of server identifiers 112, 114 are displayed is shown in FIG. 4G.

In some examples, the hardware processor 104 may receive a selection of one or more of the displayed identifiers 112, 114 of the servers 150a-150| for the selected identifiers 112, 114 to be added to a server list. For instance, a user may select the servers 150a-150I that the user intends to include in the server list and the hardware processor 104 may store the selected server identifiers 112, 114 in a server list. The hardware processor 104 may also execute the instructions 308 to add the selected identifiers 112, 114 of the selected servers 150a-150I in the server list, which may be stored in the data store 108.

In some examples, the hardware processor 104 may receive a selection of one of the servers 150a associated with the displayed identifiers 112, 114. For instance, a user may select a particular one of the servers 150a against which the hardware processor 104 is to execute a throughput test.

The hardware processor 104 may execute the instructions 310 to receive an instruction to execute a throughput test at a predefined throughput. In other words, the hardware processor 104 may receive an instruction to execute the throughput test with a server 150a that communicated over a network 130 at a throughput that meets or exceeds the predefined throughput.

Based on receipt of the instruction to execute the throughput test, the hardware processor 104 may execute the instructions 312 to access a profile 116 associated with the predefined throughput. In some examples, a user may have defined at least one profile 116, which may be stored in the data store 108. The profile 116 may define a number of options that a user may have selected to be applied during execution of a throughput test as discussed herein. The profile 116 may include, for instance, a selected predefined throughput, a certain test location, the port 12 to be used, whether the server to be used for the test is to be automatically selected, whether a line rate 420 is to be enabled, the test service provider 140 to be used for the test, and/or the like.

In some examples, the options that the user may select may include a line rate option 420 as shown in FIG. 4D and the hardware processor 104 may store a line rate option status 118 in the data store 108. For instance, the hardware processor 104 may execute the instructions 314 to determine whether a line rate option 420 has been enabled. In instances in which the line rate option 420 has been enabled, the hardware processor 104 may disregard packets received out of order and lost packets from a server 150a during execution of a throughput test with the server 150a. As a result, for instance, the testing of the throughput may be provisioned to the predefined threshold, e.g., 5 gigabits per second or higher, instead of to a lower threshold due to network issues. However, based on a determination that the line rate option 420 has been disabled, the hardware processor 104 may include packets received out of order and lost packets from the server 150a during execution of a throughput test with the server 150a. As a result, for instance, network issues may potentially affect the throughput resulting from the throughput test. In some examples, the hardware processor 104 may determine when packet loss or out of order packets have occurred. In these examples, the hardware processor 104 may inform a user of these occurrences such as by displaying notifications of these occurrences on a display.

The hardware processor 104 may execute the instructions 316 to execute the throughput test. For instance, the hardware processor 104 may cause the test instrument 10 to execute the throughput test based on the options selected in a profile 116. In other words, the hardware processor 104 may send an instruction or may otherwise cause the test instrument 10 to execute the throughput test. This may include the execution of the throughput test through a selected port 12 of the test instrument 10, based on whether the line rate option 420 has been enabled, and/or the like.

The test instrument 10 may send results of the throughput test to the hardware processor 104 and the hardware processor 104 may calculate network characteristics from the results of the throughput test. A screenshot of an example GUI 424 that shows the results of a throughput test is shown in FIG. 4H. Particularly, for instance the GUI 424 shows that the test has been completed and that the results meet or exceed some thresholds as denoted by the check mark 426. The network characteristics may include a download speed 428, an upload speed 430, a jitter measurement 432, etc.

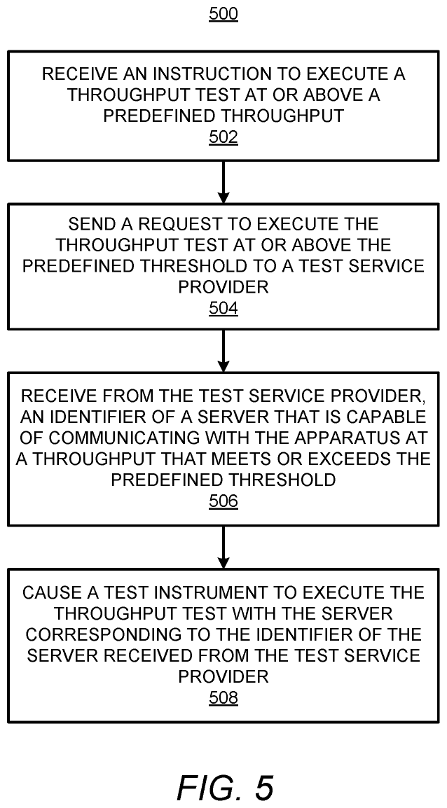

Various manners in which the hardware processor 104 of the apparatus 102 may operate are discussed in greater detail with respect to the method 500 depicted in FIG. 5. Particularly, FIG. 5 depicts a flow diagram of a method 500 for executing a throughput test for a test instrument 10 with a server 150a that is capable of communicating with the test instrument 10 at or above a predefined throughput, according to an example of the present disclosure. It should be understood that the method 500 may include additional operations and that some of the operations described therein may be removed and/or modified without departing from the scope of the method 500. The description of the method 500 is made with reference to the features depicted in FIGS. 1A-4H for purposes of illustration.

At block 502, the hardware processor 104 may receive an instruction to execute a throughput test of the test instrument 10 with a server 150a over a network 130 at or above a predefined throughput. That is, the hardware processor 104 may receive an instruction from a user via a GUI, e.g., the GUI 400 shown in FIG. 4A, to execute a throughput test of a network connection that the test instrument 10 has with a testing server 150a. As discussed herein, a user may enter the instruction to execute the throughput test through a “one click” operation.

At block 504, the hardware processor 104 may send a request to execute the throughput test at or above the predefined throughput to a test service provider 140. The hardware processor 104 may directly send the request or may send the request through the test instrument 10. As discussed herein, the test service provider 140 may have been provided with identifiers of servers 150a-150I that have previously communicated with the apparatus 102 (or another apparatus) at or above the predefined throughput. The test service provider 140 may thus have a stored thereon a list of servers 150a-150I that are capable of reaching throughputs that meet or exceed the predefined throughput. As discussed herein, the list of servers may be a custom list of server identifiers 114 for a certain organization.

At block 506, the hardware processor 104 may receive from the test service provider 140, an identifier 112, 114 of a server 150a that is capable of communicating with the apparatus 102 at a throughput that meets or exceeds the predefined throughput. The hardware processor 104 may access the stored list of identifiers 112, 114 of the servers 150a-150I that are capable of meeting or exceeding the predefined throughput and may select one or more of the servers 150a-150I. In some examples, the hardware processor 104 may select a server 150a from the list of identifiers 112, 114 based on, for instance, geographic proximities between the apparatus 102 and the servers 150a-150I.

At block 508, the hardware processor 104 may cause the test instrument 10 to execute the throughput test with the server 150a corresponding to the identifier 112, 114 of the server 150a received from the test service provider 140. For instance, the hardware processor 104 may send an instruction to execute the throughput test to the test instrument 10 through the connection interface 110 and the test instrument 10 may receive the instruction through the telemetry interface 14. As the testing server 150a may have previously been determined as being capable of communicating over the network 130 with a throughput that meets or exceeds the predefined throughput, the throughput that the test instrument 10 is capable of achieving over the network 130 may not be limited below the predefined throughput by the testing server 150a.

In some examples, the hardware processor 104 may access a profile 116 associated with the predefined throughput as discussed herein. In addition, the hardware processor 104 may execute the throughput test with the server 150a based on options selected in the accessed profile 116. The options may include, for instance, a particular testing server 150a, a certain connection interface 110a, whether a line rate option 118 has been enabled, etc.

In some examples, the hardware processor 104 may cause icons corresponding to a plurality of ports 12 on the test instrument 10 to be displayed. In these examples, the hardware processor 104 may receive a selection of a port 12 of the plurality of ports 12, for instance, from a user. The hardware processor 104 may also cause the test instrument 10 to execute the throughput test with the server 150a through the selected port 12.

In some examples, the hardware processor 104 may determine whether a line rate option 420 has been enabled. Based on a determination that the line rate option 420 has been enabled, the hardware processor 104 may disregard packets received out of order and lost packets from the server 150a during execution of the throughput test with the server 150a. However, based on a determination that the line rate option 420 has been disabled, the hardware processor 104 may include packets received out of order and lost packets from the server 150a during execution of the throughput test with the server 150a.

In some examples, the hardware processor 104 may receive identifiers 112, 114 of a plurality of servers 150a150I that are capable of communicating over the network 130 at a throughput that meets or exceeds the predefined throughput. In addition, the hardware processor 104 may cause the received identifiers 112, 114 to be displayed. The hardware processor 104 may receive a selection of one of the servers 150a, e.g., from a user, associated with the displayed identifiers. The hardware processor 104 may further execute the throughput test with the selected one of the servers 150a.

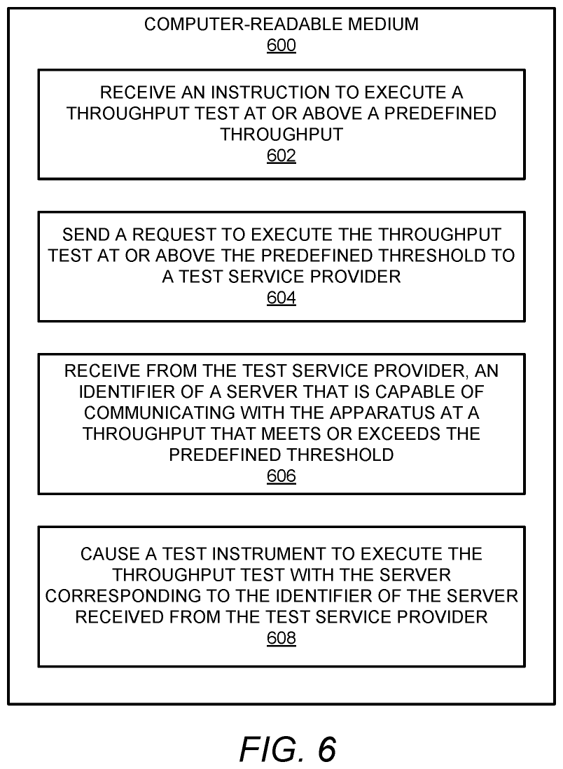

Turning now to FIG. 6, there is shown a block diagram of a computer-readable medium 600 that may have stored thereon computer-readable instructions to execute a throughput test for a test instrument 10 with a server 150a that is capable of communicating with the test instrument 10 at or above a predefined throughput, according to an example of the present disclosure. It should be understood that the computer-readable medium 600 depicted in FIG. 6 may include additional instructions and that some of the instructions described herein may be removed and/or modified without departing from the scope of the computer-readable medium 600 disclosed herein. The computer-readable medium 600 may be a non-transitory computer-readable medium, in which the term “non-transitory” does not encompass transitory propagating signals.

The computer-readable medium 600 may have stored thereon computer-readable instructions 602-608 that a processor, such as the hardware processor 104 of the apparatus 102 depicted in FIGS. 2-3, may execute. The computer-readable medium 600 may be an electronic, magnetic, optical, or other physical storage device that contains or stores executable instructions. The computer-readable medium 600 may be, for example, Random Access memory (RAM), an Electrically Erasable Programmable Read-Only Memory (EEPROM), a storage device, an optical disc, and the like.

The processor may fetch, decode, and execute the instructions 602 to receive an instruction to execute a throughput test of a test instrument 10 over a network 130 at or above a predefined throughput. The processor may fetch, decode, and execute the instructions 604 to send a request to execute the throughput test at or above the predefined throughput to a test service provider 140. The processor may fetch, decode, and execute the instructions 606 to receive, from the test service provider 140, an identifier 112, 114 of a server 150a that is capable of communicating with the test instrument 10 at a throughput that meets or exceeds the predefined throughput. The processor may fetch, decode, and execute the instructions 608 to execute the throughput test with the server 150a corresponding to the identifier 112, 114 of the server 150a received from the test service provider 140.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

1. An apparatus comprising:
a hardware processor; and
a memory on which is stored machine-readable instructions that, when executed by the hardware processor, cause the hardware processor to:
determine throughputs at which a plurality of servers communicated over a network through execution of throughput tests;
identify which servers of the plurality of servers communicated over the network at a throughput that meets or exceeds a predefined throughput; and
send identifiers of the identified servers to a third party test service provider via an external network, wherein the test service provider is to, in response to receipt of a request for execution of a throughput test that meets or exceeds the predefined throughput, at least one of:
output an identifier of at least one of the identified servers to execute the throughput test; and
select one of the identified servers to execute the throughput test.

2. The apparatus of claim 1, wherein the instructions cause the hardware processor to:
define a set of the identified plurality of servers that communicated over the network at a throughput that meets or exceeds the predefined throughput as a custom list of servers for an organization; and
send a custom list of server identifiers to the test service provider, wherein the test service provider is to, in response to receipt of a request for execution of a throughput test that meets or exceeds the predefined throughput from a member of the organization, at least one of:
output an identifier of at least one of the servers in the custom list of server identifiers to execute the throughput test; and
select one of the identified servers in the custom list of server identifiers to execute the throughput test.

3. The apparatus of claim 1, wherein the instructions cause the hardware processor to:
identify a set of servers of the plurality of servers that communicated over the network at a throughput that meets or exceeds a second predefined throughput, the second predefined throughput differing from the predefined throughput; and
send identifiers of the set of servers to the third party test service provider, wherein the third party test service provider is to, in response to receipt of a request for execution of another throughput test that meets or exceeds the second predefined throughput, at least one of:
output an identifier of at least one of the servers in the set of servers to execute the another throughput test; and
select one of the servers in the set of servers to execute the throughput test.

4. The apparatus of claim 1, wherein the instructions cause the hardware processor to:
receive an instruction to execute a throughput test with a server that communicated at a throughput that meets or exceeds the predefined throughput;
based on receipt of the instruction to execute the throughput test:
access a profile associated with the predefined throughput; and
execute the throughput test with the server based on information contained in the accessed profile.

5. The apparatus of claim 1, wherein the instructions cause the hardware processor to:
receive identifiers of a plurality of the identified servers that communicated over the network at a throughput that meets or exceeds the predefined throughput;
cause the identifiers of the received plurality of identified servers to be displayed;
receive a selection of one of the servers associated with the displayed identifiers; and
cause a test instrument to execute a throughput test using the selected one of the servers.

6. The apparatus of claim 1, wherein the instructions cause the hardware processor to:
receive identifiers of a plurality of the identified servers that communicated over the network at a throughput that meets or exceeds the predefined throughput;
cause the identifiers of the received plurality of identified servers to be displayed;
receive a selection of one or more of the servers associated with the displayed identifiers to add to a server list; and
add the identifiers of the received selection of the one or more servers in the server list.

7. The apparatus of claim 1, wherein the instructions cause the hardware processor to:
determine whether a line rate option has been enabled;
based on a determination that the line rate option has been enabled, disregard packets received out of order and packet loss from a server during execution of a throughput test with the server; and
based on a determination that the line rate option has been disabled, include packets received out of order and lost packets from a server during execution of a throughput test with the server.

8. The apparatus of claim 1, wherein the instructions cause the hardware processor to:
cause icons corresponding to a plurality of ports in a test instrument to be displayed;
receive a selection of a port of the plurality of ports; and
cause the test instrument to execute the throughput test with a server through the selected port.

9. The apparatus of claim 1, wherein the predefined throughput is 2.5 gigabits per second, 5 gigabits per second, or 10 gigabits per second.

10. A method comprising:
receiving, by a hardware processor of an apparatus, an instruction to cause a test instrument to execute a throughput test with a server over a network at or above a predefined throughput;
sending, by the hardware processor, a request via an external network to execute the throughput test at or above the predefined throughput to a third party test service provider;
receiving, by the hardware processor, and from the third party test service provider, an identifier of a server that is capable of communicating with the apparatus at a throughput that meets or exceeds the predefined throughput; and
causing, by the hardware processor, the test instrument to execute the throughput test with the server corresponding to the identifier of the server received from the third party test service provider.

11. The method of claim 10, further comprising:
accessing a profile associated with the predefined throughput; and
causing the test instrument to execute the throughput test with the server based on options selected in the accessed profile.

12. The method of claim 10, further comprising:
providing a user interface on which is displayed options for a profile;
receiving inputs from a user regarding the displayed options;
storing the inputs for the displayed options as part of the profile; and
causing the test instrument to execute the throughput test with the server based on the stored inputs of the profile.

13. The method of claim 10, further comprising:
receiving identifiers of a plurality of servers that are capable of communicating over the network at a throughput that meets or exceeds the predefined throughput;
causing the received identifiers to be displayed;
receiving a selection of one of the servers associated with the displayed identifiers; and
wherein causing the test instrument to execute the throughput test further comprises causing the test instrument to execute the throughput test with the selected one of the servers.

14. The method of claim 10, further comprising:
receiving identifiers of a plurality of servers that are capable of communicating over the network at a throughput that meets or exceeds the predefined throughput;
causing the received identifiers to be displayed;
receiving a selection of one or more of the servers associated with the displayed identifiers to add to a server list; and
adding the identifiers of the received selection of the one or more servers in the server list.

15. The method of claim 10, further comprising:
determining whether a line rate option has been enabled;
based on a determination that the line rate option has been enabled, disregarding packets received out of order and lost packets from the server during execution of the throughput test with the server; and
based on a determination that the line rate option has been disabled, including packets received out of order and lost packets from the server during execution of the throughput test with the server.

16. The method of claim 10, further comprising:
causing icons corresponding to a plurality of connection interfaces to be displayed;
receiving a selection of a connection interface of the plurality of connection interfaces; and
wherein executing the throughput test further comprises executing the throughput test with the server through the selected connection interface.

17. A non-transitory computer-readable medium on which is stored machine-readable instructions that when executed by a hardware processor, cause the hardware processor to:
receive an instruction to cause a test instrument to execute a throughput test over a network at or above a predefined throughput;
send, via an external network, a request to execute the throughput test at or above the predefined throughput to a third-party test service provider;
receive, from the third-party test service provider, an identifier of a server that is capable of communicating with the test instrument at a throughput that meets or exceeds the predefined throughput; and
cause the test instrument to execute the throughput test with the server corresponding to the identifier of the server received from the test service provider.

18. The non-transitory computer-readable medium of claim 17, wherein the instructions further cause the hardware processor to:
access a profile associated with the predefined throughput; and
execute the throughput test with the server based on options selected in the accessed profile, wherein the predefined throughput exceeds 2.5 gigabits per second.

19. The non-transitory computer-readable medium of claim 17, wherein the instructions further cause the hardware processor to:
receive identifiers of a plurality of servers that are capable of communicating over the network at a throughput that meets or exceeds the predefined throughput;
cause the received identifiers to be displayed;
receive a selection of one of the servers associated with the displayed identifiers; and
cause the test instrument to execute the throughput test with the selected one of the servers.

20. The non-transitory computer-readable medium of claim 17, wherein the instructions further cause the hardware processor to:
determine whether a line rate option has been enabled;
based on a determination that the line rate option has been enabled, disregard packets received out of order and lost packets from the server during execution of the throughput test with the server; and
based on a determination that the line rate option has been disabled, include packets received out of order and lost packets from the server during execution of the throughput test with the server.
